(19) United States
(12) Patent Application Publication
(10) Pub. No.: US 2026/0004942 A1
(43) Pub. Date: Jan. 1, 2026

(54) ZIRCONIUM-GRAPHENE COVETIC MATERIAL FOR NUCLEAR FUEL CELL CLADDING APPLICATIONS

(71) Applicant: Lyten, Inc., San Jose, CA (US)

(72) Inventors: Michael Stowell, Sunnyvale, CA (US); Lauren Sienko, Champaign, IL (US); Dhruval Patel, Champaign, IL (US)

(21) Appl. No.: 19/249,935

(22) Filed: Jun. 25, 2025

Related U.S. Application Data
(60) Provisional application No. 63/664,608, filed on Jun. 26, 2024.

(51) Int. Cl. G21C 3/07

(52) U.S. Cl. CPC G21C 3/07

(57) ABSTRACT

A nuclear fuel cell cladding that includes a zirconium-carbon covetic material. The zirconium-carbon covetic material has a carbon component associated with the surface of zirconium particles. The amount of carbon present in the zirconium-carbon covetic material is in a range of greater than 0.1 wt % to about 25 wt % of the zirconium-carbon covetic material. The carbon component may include carbon nanotubes, carbon nanomaterials, graphene, or graphene nanoplatelets. The carbon component may be uniformly distributed within the zirconium matrix. The zirconium-carbon covetic material may be formed from a zirconium alloy. The zirconium-carbon covetic material may be configured for use in various types of nuclear reactors. The synthesis of the cladding involves a process of plasma-enhanced chemical vapor deposition. The resulting nuclear fuel cell cladding offers improved performance and reliability for nuclear reactor applications.

### CROSS-REFERENCE TO RELATED APPLICATIONS

This application claims priority to U.S. Provisional Patent Application No. 63/664,608, titled “COVETIC ZIRCONIUM FOR NUCLEAR FUEL CELL CLADDING APPLICATIONS”, filed Jun. 26, 2024, which is assigned to the assignee hereof; the disclosures of which is considered part of and is incorporated by reference in this Patent Application.

### FIELD OF THE INVENTION

The present disclosure relates to nuclear reactor technology, and more particularly to a novel nuclear fuel cell cladding material composed of a zirconium matrix integrated with graphene covetics.

### BACKGROUND

The field of nuclear energy has long been grappling with challenges related to fuel cladding integrity. Fuel cladding, a protective barrier concealed within the core of a nuclear reactor, plays a central role in ensuring the safe and efficient operation of these reactors. This element is exposed to harsh environments, including radiation-induced damage, thermal stress, corrosion, and hydrogen-induced embrittlement. These factors often compromise the cladding materials, which may cause premature fuel rod replacement before all of the nuclear fuel has been spent.

Moreover, nuclear cladding serves as a dual-purpose protective barrier that isolates the radioactive materials from the coolant. However, recent reports stress the need for improved cladding material to prevent fuel failure rates. Fuel failures can threaten the competitive advantage of the low production cost of nuclear power through lost generation, increased inspection and repair costs, and the premature discharge of fuel assemblies, which can be substantial.

Lowering the fuel failure rates would keep existing nuclear power plants operating to the fullest extent and renew public trust in the nuclear sector's ability to provide safe, reliable, and significant contributions to zero-carbon emission power sources. The selection of appropriate materials for fuel cladding continues to be a challenge because the desirable materials preferably have a combination of high-temperature stability, corrosion resistance, and mechanical strength.

### SUMMARY

According to an aspect of the present disclosure, a nuclear fuel cell cladding is provided. The cladding includes a zirconium-carbon covetic material that has a carbon component associated with the surface of zirconium particles. The amount of carbon present in the zirconium-carbon covetic material may be in a range of greater than 0.1 wt % to about 25 wt % of the zirconium-carbon covetic material. The integration of carbon in zirconium cladding material may enhance the mechanical, thermal, and radiation-resistant characteristics of the zirconium matrix, thereby improving the performance and reliability of the nuclear fuel cell cladding.

According to other aspects of the present disclosure, the nuclear fuel cell cladding may include one or more of the following features. The carbon component may include carbon nanotubes, carbon nanomaterials, or graphene. Graphene may include graphene nanoplatelets, multilayer graphene, etc. offering flexibility in the choice of carbon-based nanomaterials for integration into the zirconium matrix. In one aspect, the graphene may be uniformly distributed within the zirconium-graphene covetic material, ensuring consistent performance across the cladding material. The graphene may be integrated into the zirconium material through a process of plasma-enhanced chemical vapor deposition, a technique that allows for precise control over the composition and distribution of the graphene throughout the zirconium-graphene covetic material.

The zirconium-graphene covetic material may be formed from a zirconium alloy, providing additional flexibility in the choice of materials for the cladding. The zirconium alloy may comprise zirconium and at least one additional metal such as tin, iron, chromium, beryllium, magnesium, silicon, aluminum, molybdenum, niobium, vanadium, and nickel. The graphene component of the zirconium-graphene covetic material may enhance the thermal conductivity of the zirconium material, enhance the radiation resistance of the zirconium material, and the mechanical strength of the zirconium material.

The nuclear fuel cell cladding may further include a protective coating applied to the exterior surface of the cladding. The protective coating may include one of the following materials: silicon carbide, alumina, zirconia, or an alloy that includes at least two of the materials. The protective coating may include a metal oxide or a nitride. The cladding may be configured for use in various types of nuclear reactors, including light water reactors, pressurized water reactors, boiling water reactors, high-temperature gas-cooled reactors, fast neutron reactors, molten salt reactors, and heavy water reactors.

Further details of aspects, objectives, and advantages of the technological aspects are described herein, and in the drawings and claims. The foregoing general description of the illustrative aspects and the following detailed description thereof are merely exemplary aspects of the teachings of this disclosure and are not restrictive.

### BRIEF DESCRIPTION OF THE DRAWINGS

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1 is a series of images of an experimental microwave reactor and processing steps, according to one aspect. Part (a) microwave reactor, part (b) zirconium powder in the microwave reactor, part (c) zirconium covetic powder collection.

FIG. 2 depicts a series of transmission electron microscopy (TEM) images of graphene coated zirconium, according to one aspect. Part (a) graphene coated zirconium, part (b) graphene islands and few-layer graphene.

FIG. 3 depicts a series of transmission electron microscopy (TEM) images of zirconium-graphene covetic materials, according to one aspect. Part (a) few-layer graphene (FLG) associated with zirconium particles, part (b) magnified view of FLG associated with surface of zirconium particle, part (c) graphene islands and FLG associated with a zirconium particle, part (d) magnified view of FLG associated with zirconium particles.

FIG. 4 a plot of Raman spectra for graphene coated zirconium, according to one aspect.

FIG. 5 depicts scanning electron microscopy (SEM) images of zirconium covetic materials, according to one aspect. Part (a) is a magnified view of a portion of a zirconium covetic material shown in part (b).

FIG. 6 depicts a plot of colorized elemental carbon and zirconium in samples (a) and (b) of graphene coated materials depicted in the inset images, according to one aspect.

### DETAILED DESCRIPTION

Nuclear cladding needs to possess resilience to endure core conditions, guaranteeing the safety of operations. Nuclear fuel cladding faces several critical issues related to thermal stress, which are of concern for the safety and performance of nuclear reactors. Thermal cycling occurs during startup, shutdown, and power changes and induces mechanical fatigue in the cladding material. Over time, the repetitive expansion and contraction of the cladding can cause it to become brittle and eventually fail, increasing the risk of accidents. Nuclear reactors operate at high temperatures to facilitate the nuclear fission process. The cladding material needs to withstand these extreme temperatures. Excessive heat can lead to the degradation of cladding materials, weakening their structural integrity, and potentially causing fuel cladding failure. At elevated temperatures, cladding materials can undergo oxidation. This can lead to the formation of oxides on the cladding surface, which may compromise the cladding's resistance to mechanical and thermal stresses. Additionally, the oxidation of cladding can result in the absorption of hydrogen, leading to embrittlement and potential failures.

Thermal stress issues become even more critical during accident scenarios like LOCAs and Loss-of-Coolant Transients (LOCTs). In such situations, rapid temperature changes and pressurized conditions can subject the cladding to severe stress, increasing the risk of failure.

Neutron embrittlement, caused by high-energy neutron exposure, induces displacement damage within the atomic structure of materials, affecting their mechanical properties, which is relevant for cladding materials, such as zirconium alloys. Neutron irradiation changes cladding material properties, including increased hardness, reduced ductility, and changes in fracture behavior. These alterations can lead to a loss of material toughness and increased susceptibility to brittle fracture. Such effects are of particular concern for cladding materials, as they need to maintain their integrity to contain the nuclear fuel and prevent the release of radioactive materials. Microstructure changes due to neutron irradiation, such as defects and point defect migration, impact the material's response to stress and thermal loads. To address these concerns, research is focused on developing radiation-resistant cladding materials.

One of the primary challenges in nuclear fuel cladding has been the corrosion of materials, especially in light water reactors (LWRs). Zirconium alloy cladding, commonly used in LWRs, is susceptible to hydrogen pickup and oxidation during normal and accident conditions, leading to cladding failure and the release of radioactive materials. Zircaloy reactor cladding has been prone to iodine stress corrosion cracking. This corrosion is associated with releasing iodine, a fission product, which can lead to cladding embrittlement and failure. Moreover, developing accurate models for cladding swelling and rupture during loss-of-coolant accidents (LOCAs) has been a complex challenge. The long-term exposure of cladding materials to radiation can lead to embrittlement and reduced performance. Managing radiation-induced defects and maintaining the integrity of the cladding has been a persistent issue.

The development of accident-tolerant fuel (ATF) cladding materials has been a significant step forward. ATF materials aim to improve the safety and performance of nuclear reactors. These materials exhibit enhanced corrosion resistance and are designed to withstand extreme conditions, reducing the risk of accidents.

Zirconium alloys have traditionally been favored for constructing fuel cladding and structural components in nuclear reactors due to their advantageous properties. Zirconium alloy cladding, which is commonly used in light water reactors, experiences thermal stress that can lead to the formation of hydrides. Hydrides can weaken the mechanical properties of the cladding and potentially lead to cracks and failure, impacting the fuel's integrity. During reactor operation, pellet-cladding interaction (PCI) can also result from differential thermal expansion between the fuel pellets and the cladding. This can lead to localized stress concentrations, which can cause cladding failure and fuel rod breaches. However, enhancing zirconium alloys having thermal transport capabilities and corrosion resistance is a persistent challenge in the nuclear industry.

Nuclear fuel cladding is susceptible to several issues related to hydrogen embrittlement, which can significantly impact nuclear reactors' structural integrity and safety. Hydrogen embrittlement occurs when hydrogen atoms diffuse into the material and weaken its mechanical properties. Key issues associated with hydrogen embrittlement in nuclear fuel cladding are primarily linked to zirconium-based alloys used in LWRs. These alloys are susceptible to corrosion and zirconium hydrides due to hydrogen absorption during reactor operation. The presence of hydrides weakens the cladding material, making it susceptible to embrittlement and potential failure. Hydrogen migration within the cladding, aggravated by mechanical loading, irradiation, and thermal cycling can lead to embrittlement, making the material more prone to cracking and failure. Embrittlement also leads to a loss of ductility in the cladding material, making it less capable of accommodating plastic deformation and more susceptible to brittle fracture.

Hydrogen embrittlement can also affect PCI by reducing the cladding's ability to accommodate the differential thermal expansion between the fuel pellets and the cladding, increasing the risk of localized stress concentrations and potential failure. Additionally, during severe accident scenarios, such as LOCAs, rapid temperature changes, and pressurized conditions can worsen hydrogen pickup and embrittlement of the cladding. This can complicate accident management and potentially compromise the cladding's ability to contain the fuel.

Research into covetic nanomaterials represents a promising avenue for improving fuel cladding materials. Covetics, which combine metals and carbon nanomaterials, have shown potential for enhanced mechanical properties and corrosion resistance. Advances in protective coatings have contributed to mitigating cladding corrosion. These coatings offer an additional layer of protection for fuel cladding materials.

Graphene, a single layer of carbon atoms arranged in a hexagonal lattice, is a fundamental structural unit in graphite, carbon nanotubes, fullerenes, and large planar aromatic hydrocarbons. In simpler terms, graphene is like a flat sheet made of tightly arranged carbon atoms, forming a pattern that looks like a honeycomb. These carbon atoms connect similarly to how they connect in benzene, and each has one unpaired electron.

Graphene also exhibits exceptional thermal conductivity, surpassing most other materials, which can be harnessed for efficient heat dissipation in electronics and advanced thermal management systems. Graphene is highly chemically inert and resistant to corrosion, ensuring its longevity and durability even in harsh environments. Graphene also serves as an effective barrier against the permeation of water and gases, finding applications in packaging materials and protective coatings. Furthermore, graphene can be seamlessly integrated into composite materials to enhance their mechanical, electrical, and thermal properties.

Covetics are crafted through a precise and meticulous process that involves embedding carbon nanotubes or graphene into a metallic matrix. This synthesis method, often employing advanced metallurgy techniques, seeks to integrate the metal and carbon components seamlessly. Achieving the right balance between these constituents is important to harnessing the remarkable properties that define covetics.

Covetic materials exhibit enhanced mechanical strength due to the reinforcement provided by carbon nanotubes or graphene, granting covetics exceptional tensile and compressive strength. Furthermore, covetics display outstanding electrical conductivity, owing to the highly conductive nature of carbon materials. Additionally, covetics offer exceptional thermal performance. The carbon components contribute to efficiently dissipating heat, making these materials invaluable for applications requiring superior thermal management, such as in the aerospace and automotive industries. Their ability to withstand extreme temperatures and rapidly conduct heat away from critical components renders them important in cutting-edge engineering solutions.

However, one of the fundamental challenges associated with covetic material production methods is the issue of achieving homogeneity in the distribution of graphene within the metal matrix. In materials science, the uniformity of carbon placement within the metal matrix and the strength of the bonding between carbon and metal are factors that dictate the resulting material properties.

For instance, aluminum alloys incorporated with carbon nanotubes (CNTs) demonstrate significant drawbacks when CNTs agglomerate, leading to an uneven distribution within the material. In such cases, the material's properties are compromised, diminishing its performance. Agglomeration disrupts the desired uniformity of the carbon placement within the metal matrix, resulting in reduced Rockwell hardness and tensile strength. Thus, there exists a persistent challenge of ensuring consistent and homogeneous distribution of carbon, such as graphene or CNTs, within the metal matrix. Failure to achieve this homogeneity can significantly hinder the realization of the desired material properties.

More recent studies include graphene coatings on zirconium alloys to function as protective barriers, shielding the zirconium alloy from corrosive agents. However, scaling up the production of graphene-coated zirconium alloys, optimizing coating thickness, and conducting long-term tests under realistic nuclear reactor conditions is challenging. In one report, coating cladding materials with graphene is limited by difficulties in producing strong adhesion and uniform coverage of the graphene coating. Ensuring that the graphene coating adheres firmly and uniformly to the cladding material can be difficult, potentially creating areas vulnerable to corrosion. Moreover, the durability of graphene coatings is a concern because the coatings degrade over time due to environmental factors or wear. Mechanical stress or extreme conditions may also lead to cracking or delamination of graphene coatings, exposing the cladding material to corrosion. Coating irregular or complex shapes with graphene poses another challenge, often resulting in uneven coverage. Additionally, the cost of graphene production and coating processes can be relatively high, limiting their widespread adoption in various applications.

According to one aspect, synthesis of zirconium-carbon covetic material represents a new and innovative approach in pursuing advanced materials with diverse applications spanning industries such as aerospace, nuclear, and automotive. In various approaches, zirconium-carbon covetic material amalgamates the exceptional characteristics of zirconium with the distinctive qualities of carbon nanotubes, graphene, etc. giving rise to a composite material poised to redefine performance standards.

### DEFINITIONS AND USE OF FIGURES

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or.” That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various aspects are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed aspects—they are not representative of an exhaustive treatment of all possible aspects, and they are not intended to impute any limitation as to the scope of the claims. In addition, an illustrated aspect need not portray all aspects or advantages of usage in any particular environment.

An aspect or an advantage described in conjunction with a particular aspect is not necessarily limited to that aspect and can be practiced in any other aspects even if not so illustrated. References throughout this specification to “some aspects” or “other aspects” refer to a particular feature, structure, material, or characteristic described in connection with the aspects as being included in at least one aspect. Thus, the appearance of the phrases “in some aspects” or “in other aspects” in various places throughout this specification are not necessarily referring to the same aspect or aspects. The disclosed aspects are not intended to be limiting of the claims.

### DESCRIPTIONS OF EXEMPLARY APPROACHES

According to one general aspect, a nuclear fuel cell cladding includes a zirconium-carbon covetic material that includes zirconium particles having a carbon component associated with a surface of the zirconium particles. The amount of the carbon component present in the zirconium-carbon covetic material may be in a range of greater than 0.1 wt % to about 25 wt % of the zirconium-carbon covetic material.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

According to one aspect, a nuclear fuel cell cladding includes a zirconium-carbon covetic material. The zirconium-carbon covetic material includes zirconium particles having a carbon component associated with a surface of the zirconium particles. In various approaches, the carbon component may include graphene, carbon nanotubes, carbon nanomaterials, carbon allotropes such as single layer graphene, multi-layer graphene, few layer graphene, etc. In some approaches, the carbon component may include any known carbon allotrope. In preferred approaches, the carbon component does not include oxygen. For example, the carbon component preferably does not include graphene oxide.

In one preferred aspect, a zirconium-graphene covetic hybrid material is produced through a controlled process involving zirconium flakes, atmospheric plasma, and rapid quenching. In preferred approaches, zirconium-graphene covetic material does not merely coat the outer surface of fuel cell cladding but also enhances cladding performance providing inherent mechanical strength. Moreover, a zirconium-graphene covetic material provides enhanced thermal conductivity that may facilitate more efficient heat transfer, improving reactor efficiency, and corrosion resistance. Moreover, potentially remarkable radiation resistance and corrosion resilience of the nuclear cladding comprised of zirconium-graphene covetic material may ensure the prolonged integrity of the cladding, reducing the risk of accidents and long-term nuclear waste management concerns.

In one approach, graphene is grown on the façade of zirconium where the graphene is an intricate hexagonal close-packed configuration in a liquified state. In some approach, the zirconium-graphene covetic material as a powder may be reformed into casts or forged, paving the way for future cladding materials. In one approach, a zirconium-graphene covetic material includes graphene grown onto zirconium particles forming a covetic material defined by zirconium infused with nanoscale-size carbon component associated with the surface of the zirconium particle.

Production of Covetic Zirconium using Atmospheric Microwave Surface Wave Plasmas

According to one aspect, to initiate the synthesis process, a method for producing covetic zirconium involves utilizing an atmospheric surface wave plasma generated with microwaves. One aspect describes a growth of graphene powders using atmospheric Plasma-Enhanced Chemical Vapor Deposition (PECVD) that involves processing with a microwave plasma torch is an innovative method that allows for synthesizing graphene in powder form, as disclosed in U.S. patent application Ser. No. 18/597,720, titled “PRISTINE GRAPHENE DISPOSED IN A METAL MATRIX”, filed Mar. 6, 2024, which is herein incorporated by reference. In this technique, gases and materials are introduced into the system to undergo decomposition into elemental and molecular vapor. Subsequently, these vaporized components are reassembled at lower temperatures to yield the desired covetic powders. In PECVD, plasma, a highly energetic and ionized gas, enhances the chemical reactions involved in the vapor deposition process. Typically, the process consists in introducing precursor gases into a low-pressure chamber, where they are activated by plasma. The activation leads to the dissociation and ionization of the precursor molecules, facilitating the growth of a thin film on a substrate or powders within the chamber.

The atmospheric PECVD setup operates at ambient pressure, unlike traditional PECVD processes that depend on a vacuum chamber. An important component of this setup is the microwave plasma torch, which generates high-energy plasma in an open environment that can operate at atmospheric pressure, simplifying the overall setup.

Precursor gases, such as hydrocarbons like methane (CH4) or ethylene (C2H4), serve as the carbon source for graphene growth and are introduced into the plasma torch. The microwave plasma torch generates an extremely high-temperature plasma through microwave energy coupling with a gas stream containing highly reactive species, including carbon radicals and ions. Carbon atoms and radicals are produced within this plasma environment, leading to carbon-containing molecule dissociation. These species are carried downstream by the gas flow and reassembled into graphene structures as they cool down, potentially resulting in the formation of graphene flakes or powders.

Control parameters, including gas flow rates, temperature, and plasma power, are carefully adjusted to customize the growth of graphene powders, allowing for fine-tuning. Graphene powders or flakes formed in the plasma are collected downstream using suitable collection devices, including substrates or containers, for further characterization and application.

Various characterization techniques, such as Raman spectroscopy, X-ray diffraction (XRD), and scanning electron microscopy (SEM), are employed to assess the synthesized graphene powders' quality, thickness, and structural properties.

Atmospheric PECVD with a microwave plasma torch offers notable advantages, including scalability, simplicity, and the potential for high production rates compared to traditional vacuum-based methods. The resulting graphene powders find applications in diverse fields, from energy storage devices like batteries and supercapacitors to advanced composite materials and conductive inks.

As previously outlined, growing graphene provides a unique perspective on graphene synthesis, as it occurs not on a substrate's surface but within the gas phase of the reactor itself. In one aspect, zirconium particles are introduced into the plasma zone, where temperatures typically range from 4000 to 5000 degrees Kelvin (deg K). Under these extreme conditions, a remarkable transformation occurs: the surfaces of the zirconium particles begin to melt, giving rise to a molten liquid surface.

The molten state of the zirconium particles creates an environment ripe for the nucleation and growth of graphene. Within this scorching-hot, high-energy plasma, carbon species from the precursor gases readily adhere to the molten zirconium surfaces. The carbon atoms and radicals, born from the plasma's intense reactivity, assemble and form graphene structures.

This intriguing phenomenon results in the production of “grapheneated powders.” These powders are characterized by their unique composition, where graphene layers have grown directly onto the surface of zirconium particles. The extraordinary properties of molten zirconium and graphene offer a fascinating prospect for diverse applications, from advanced materials to innovative technologies. The synthesis process leverages the extreme conditions within the plasma zone to create a distinctive class of materials with potential benefits across various industries.

### Synthesis of Zirconium-Graphene Hybrid Material via Atmospheric Plasma-Enhanced Chemical Vapor Deposition

According to one aspect, a zirconium-graphene hybrid material is synthesized by injecting zirconium particles into a plasma reactor, where the atmospheric plasma facilitates the growth of graphene onto the molten liquid metal surface of these particles. A new material is generated and then stabilized by quickly quenching the modified particles downstream of the plasma volume in the collection volume.

The experimental setup includes a specialized plasma reactor designed to operate under atmospheric pressure conditions. This reactor has a gas injection system tailored to the experiment's requirements. Zirconium particles are introduced into the plasma reactor using a controlled feeder system, ensuring precise control over the flow rate of the flakes into the reactor chamber.

An atmospheric plasma is generated within the reactor using a Muggee 10 KW 2.45 GHz microwave power source. This process typically involves a mixture of inert and process gases such as argon and methane. As microwave energy is absorbed into the gas mixture, it triggers plasma formation with temperatures reaching up to 5000 degrees Kelvin. The energy level can be adjusted via microwave power control to facilitate the chemical reactions for graphene growth.

In the high-temperature plasma environment, the zirconium particles are exposed to extreme temperatures and energetic conditions, causing the surface of the zirconium metal to melt. Simultaneously, methane (CH4) dissociates in the plasma, releasing carbon atoms. These carbon atoms deposit on the molten zirconium surface, leading to the formation of few-layer graphene layers.

Downstream of the plasma volume, there is a rapid decrease in temperature, which constitutes the quenching process. This rapid cooling process may be important for solidifying the zirconium-graphene hybrid material promptly. It plays an important role in preserving the synthesized structure by effectively trapping the graphene layer within the metal lattice and preventing further growth or agglomeration of graphene.

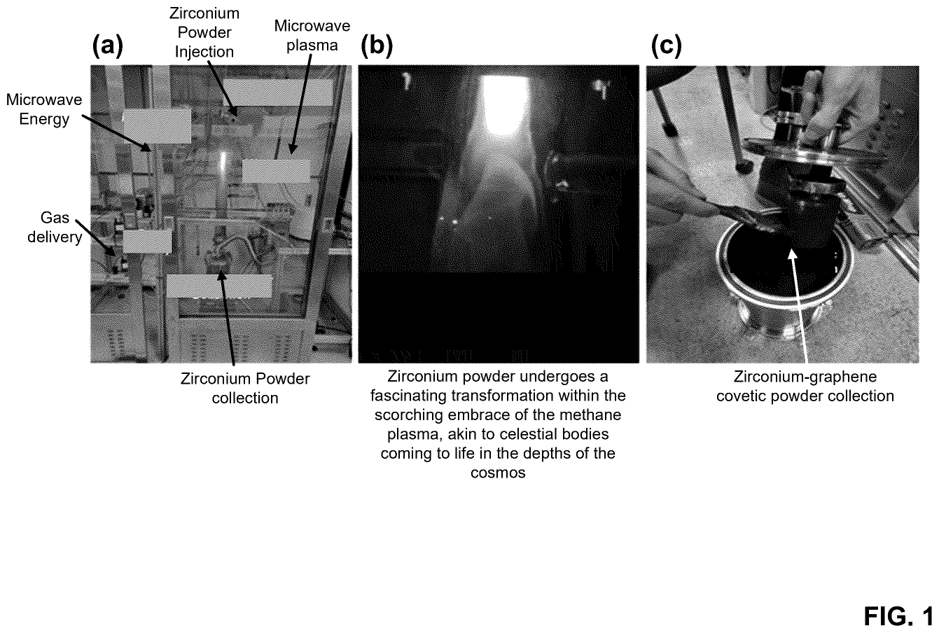

FIG. 1 part (a) depicts an image of an experimental Microwave Reactor. The reactor includes a region for injection of zirconium powder, microwave energy, microwave plasma, gas delivery, and zirconium powder collection. Part (b) is an image of zirconium powder undergoing the transformation within the scorching embrace of methane plasma. Part (c) shows the collection of zirconium covetic powder collection. Following the synthesis process, comprehensive characterization of the zirconium-graphene hybrid material is important to evaluate its structural, chemical, and physical properties. Various techniques, including scanning electron microscopy (SEM), transmission electron microscopy (TEM), X-ray diffraction (XRD), Raman spectroscopy, and X-ray photoelectron spectroscopy (XPS), can be employed to assess the quality and composition of the newly synthesized material.

### Experimental Configuration and Material Processing

According to one aspect, zirconium covetics, e.g., graphene covetic zirconium, may be formulated as a powder. In one approach, zirconium covetics may be formed as a singular, monolithic covetic ingot. As described here, a selection of analytical techniques may be used to authenticate the proliferation of graphene upon the façades of the semi-liquified zirconium materials.

In various approaches, the zirconium particles in a zirconium-carbon covetic material may include a zirconium alloy. In one approach, the zirconium particles include a zirconium-containing alloy (e.g., super alloys), such as Zircaloy. In various approaches, the zirconium-carbon covetic material includes zirconium and at least one of the following metals: tin, iron, chromium, nickel, beryllium, magnesium, silicon, aluminum, molybdenum, niobium, vanadium, etc.

In various approaches, zirconium-graphene covetic powders, serving as the output product, are characterized using advanced techniques such as Transmission Electron Microscopy (TEM), Scanning Electron Microscopy (SEM), and Energy Dispersive Spectrometry (EDS). These analytical methodologies are primarily instituted to corroborate the genesis of graphene nanoplatelets adorning the surfaces of molten zirconium chips. Furthermore, the EDS is used to delineate elemental concentrations while verifying the proliferation of graphene.

### Structural Materials Morphology

According to one aspect, a fabrication process as described herein results in the deposition of the carbon component on the surface of zirconium particles. In some approaches, the carbon component is coupled, connected, intimately connected, bound, bonded etc. to the surface of zirconium particles. In various approaches, graphene, such as FLG, graphene platelets, etc. is coupled to the surface of zirconium particles.

In one approach, the zirconium-graphene covetic may be characterized by bonding between the graphene and zirconium at the graphene edge. Moreover, the bonding between the graphene edge and zirconium may have a covalent character. Preferably, zirconium-graphene covetics include defect-laden graphene characterized as having edges available for bonding to the surface of zirconium particles. In preferred approaches, zirconium-graphene covetics are characterized by graphene “pinned” to the surface of zirconium particles. In one approach, the zirconium-graphene covetic material is a covetic covalent metallic bonded material.

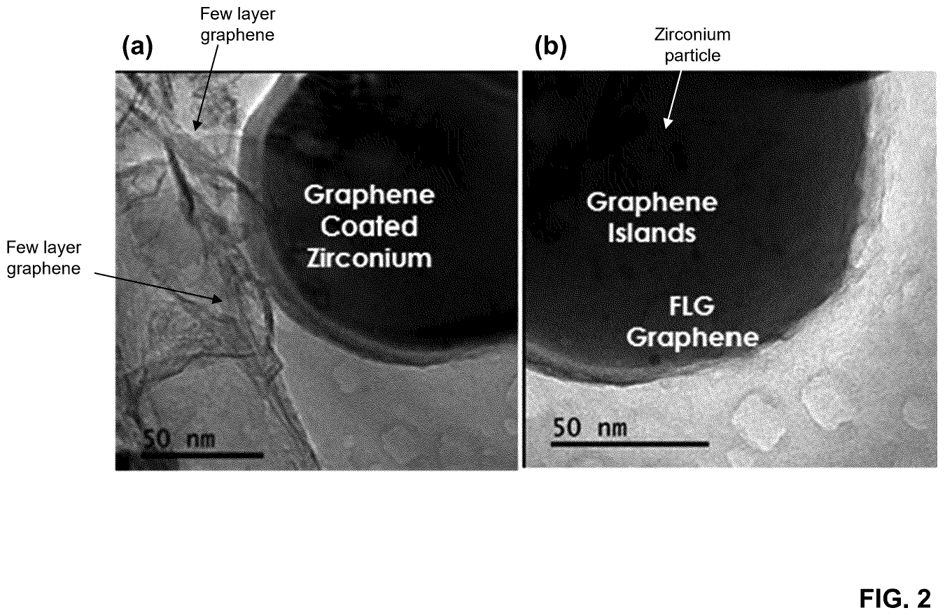

Analysis of zirconium-carbon covetic material may be examined using transmission electron microscopy (TEM) as illustrated in FIG. 2. The two TEM images (parts (a) and (b)) depict two different zirconium particles coated with graphene. In one approach, graphene forms on the surfaces of the molten zirconium particles. The zirconium coated with graphene comprises a zirconium carbon covetic material. The magnified image in part (a) depicts a spherical zirconium particle associated with graphene on its surface. The zirconium particle in part (b) illustrates graphene islands and few layer graphene (FLG) associated with the surface of the zirconium particle. This graphene coating is responsible for the distinctive black specks prominently observed on the surfaces of these spheres. This analysis not only corroborates the presence of carbon but also reveals that the carbon layer may be composed of graphene nanoplatelets. The TEM images displayed the distinctive two-dimensional lattice structure of graphene, further substantiating the synthesis of graphene on the zirconium substrate (e.g., surface of the zirconium particle).

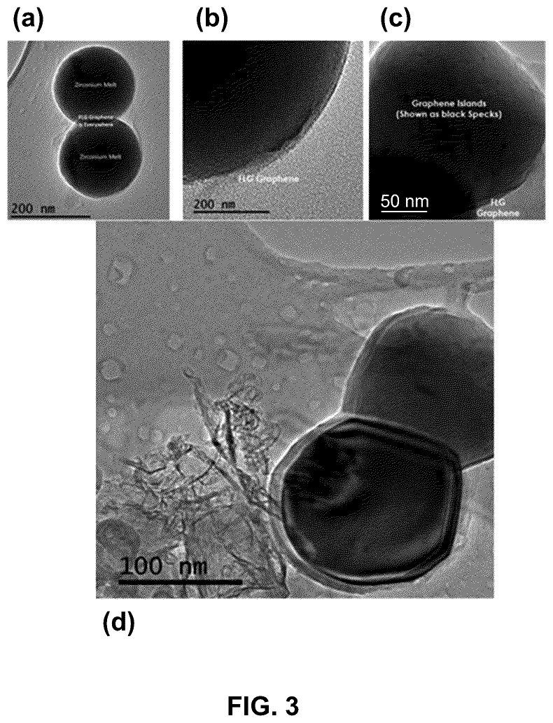

FIG. 3 illustrates TEM images of zirconium-graphene covetic material, according to one aspect. The image in parts (a) and (b) illustrate zirconium particles having few layer graphene (FLG) associated with the surface of the zirconium particles. The magnified image of part (c) illustrates graphene islands and FLG associated with the surface of a zirconium particle. The image in part (d) illustrates the distinctive two-dimensional lattice structure of the FLG associated with the surface of zirconium particles. Without wishing to be bound by any theory, it is believed edges of the graphene are pinned to the zirconium particles thereby increasing the solubility of the graphene in the molten zirconium. Consequently, the pinned graphene contributes to increased elasticity and mechanical strength of the zirconium.

According to one aspect, the presence of graphene associated with the surface of zirconium particles (e.g., graphene coated zirconium particles) allows the zirconium-graphene material to be heated to the melting temperature of zirconium, the zirconium-graphene covetic material is mixed in a dry space and a material is formed with uniformly dispersed graphene.

In various approaches, the carbon component of the zirconium-carbon covetic material is uniformly integrated within the zirconium material. The integrated carbon component in the zirconium-carbon covetic material has physical characteristics of being integrated using the process of plasma-enhanced chemical vapor deposition. For example, graphene is distributed, dispersed, etc. throughout the zirconium-graphene covetic material. In various approaches, graphene pinned to the surface of zirconium particles allow the graphene to become “wettable” and having a greater solubility in a zirconium material compared to graphene that is not pinned to zirconium particles.

A combined EDS and TEM analyses provides a robust foundation for the assertion that the desired zirconium-graphene hybrid material has been synthesized, setting the stage for further exploration and application of this innovative material in various domains.

### Graphene Quality

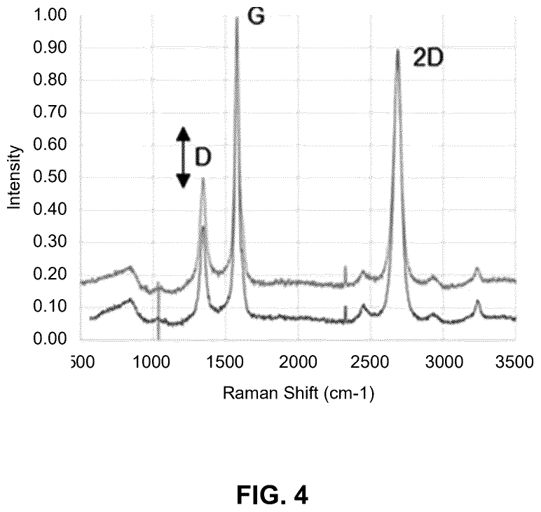

In one approach, Raman spectroscopy provide evidence that the deposition process successfully yielded high-quality graphene layers on the surfaces of the molten zirconium spheres. This outcome underscores the effectiveness and precision of the graphene deposition method employed in this study. As illustrated in the Raman spectrophotometry results in FIG. 4, distinct Raman peaks corresponding to graphene's characteristic vibrational modes, such as the G and 2D bands, were observed in the spectra, confirming the presence of graphene layers. It is well-knowns that in monolayer graphene, first-order Raman and double resonance Raman scattering exhibit critical features in their spectra: a prominent G-band at 1582 cm−1 (graphite) and a D-band at approximately 2700 cm−1 when excited with a 2.41 eV laser. In disordered or edge regions of graphene samples, an additional disorder-induced D′-band emerges, occurring at roughly half the frequency of the G-band (around 1350 cm−1 under 2.41 eV laser excitation). As depicted in FIG. 3, the peak shapes and positions of graphene-coated zirconium suggest the formation of well-structured and defect-free graphene on the zirconium surfaces, indicative of the robustness of the deposition process.

### Zirconium to Graphene Ratio

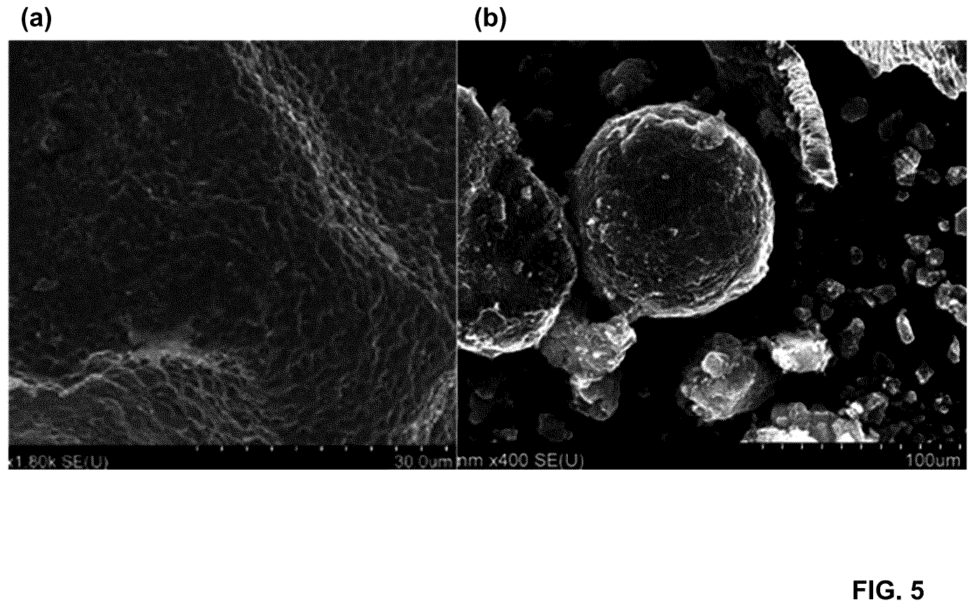

Upon further investigation, the subsequent Energy-Dispersive X-ray Spectroscopy (EDS) analysis offers evidence supporting the composition of these materials. It unequivocally confirms that the black specks on the zirconium spheres are zirconium particles enveloped by a carbonaceous layer. FIG. 5 depicts scanning electron microscopy (SEM) images of a surface of zirconium particle coated with graphene (part (a)) and a lower magnification of zirconium particles coated with graphene (part (b)). A closer, more detailed examination of the EDS of these samples results reveals the presence of two distinct carbonaceous components: Few-Layer Graphene (FLG) and graphene nanoplatelets. This dual presence signifies the richness and complexity of the graphene layers that have developed during the synthesis process.

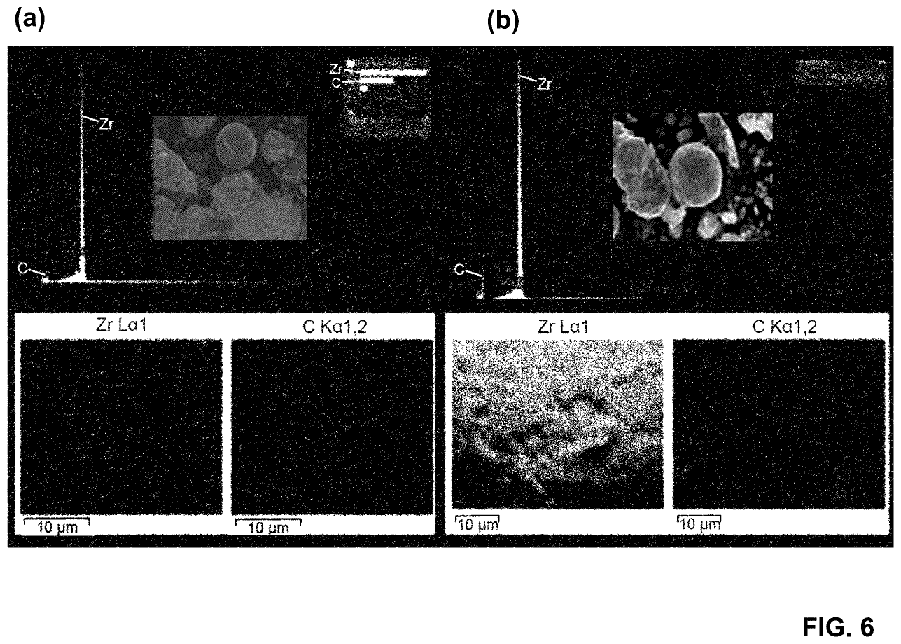

Drawing upon the quantitative data presented in FIG. 6, alongside comprehensive elemental analysis conducted both at discrete target sites and systematically across a broad set of locations within the bulk material, the incorporation of graphene is characterized as a dopant within the zirconium matrix. This multi-point compositional mapping—enabled through techniques such as energy-dispersive X-ray spectroscopy (EDS) and corroborated by cross-sectional sampling—reveals a relatively uniform distribution of graphene throughout the zirconium structure. Based on these measurements, the doping concentration is calculated to be approximately 0.1% graphene by weight relative to zirconium. This low but deliberate dopant loading suggests effective integration at the atomic level without the formation of secondary zirconium-rich phases, thereby indicating a successful and spatially consistent doping process likely to influence the material's electronic, catalytic, or thermal properties in a controlled manner.

As illustrated in the elemental maps of parts (a) and (b) of FIG. 6, the spatial distribution of elements within the particle is clearly resolved, with the left-hand panel representing the zirconium signal and the right-hand panel corresponding to carbon, which in this context denotes the graphene phase. The elemental percentages were inferred from the degree of areal coverage observed in the maps. For this specific particle, the relative signal intensities and coverage suggest that carbon comprises approximately 0.1% by weight-consistent with the broader compositional analysis and reinforcing the conclusion of a low-concentration but homogeneously distributed graphene zirconium doping in the zirconium graphene matrix.

In addition to this representative sample, other materials synthesized over the course of the study demonstrated higher levels of graphene zirconium incorporation into the zirconium matrix. Specifically, several samples exhibited doping concentrations of up to 1% by weight of zirconium, highlighting the tunability of the doping process and suggesting a pathway for further optimization of material properties through controlled adjustment of dopant levels. In some approaches, samples of zirconium-graphene covetic material may include a uniform distribution graphene in a range of greater than about 0.1 wt % to about 25 wt % of total zirconium, or about 0.1wt % to about 10 wt % of total zirconium, or about 0.1 wt % to about 5 wt % of total zirconium, or about 0.1 wt % to about 1 wt % of total zirconium, or about 0.5 wt % to about to about 25 wt %, 0.5 wt % to about 10 wt % of total zirconium, or about 0.5 wt % to about 5 wt % of total zirconium, etc. Without wishing to be bound by any theory, at amounts greater than 25 wt %, graphene may begin to agglomerate in the zirconium material and possibly ameliorate the mechanical strength of the zirconium material.

In various approaches, analysis of structural and microstructural changes in zirconium-graphene covetic materials may lead to enhanced nuclear fuel cladding. In one aspect, the zirconium-graphene covetic material may exhibit alterations to the atomic and/or crystalline structure of the zirconium and/or graphene.

In one consideration, a transformation of zirconium and graphene to a zirconium-graphene covetic material may involve a shift in the crystal structure of zirconium covetic material. Covetic materials, incorporating elements like graphene or other carbon-based nanomaterials, have been shown to have unique crystal structures when contrasted with traditional materials. These structural changes may potentially affect critical material properties such as mechanical strength, thermal conductivity, and resistance to radiation. Moreover, graphene or carbon-based nanomaterials may introduce defects or dislocations within the zirconium's crystal lattice.

In one approach, a homogeneous distribution of graphene within the zirconium matrix may be achieved by ensuring the uniformity of microstructural features during synthesis and subsequent processing stages is important in guaranteeing consistent performance within nuclear fuel cladding applications. In one approach, incorporation of carbon nanotubes, graphene, carbon nanomaterials, etc. may impart exceptional mechanical strength to the zirconium matrix comprised of carbon coated zirconium particles.

In some approaches, structural changes may encompass phase transitions within the zirconium-graphene covetic material, leading to alterations in atomic arrangements or the emergence of novel phases. These phase changes may significantly impact the material's response to radiation, temperature variations, and mechanical stresses. For example, zirconium-carbon covetic material may exhibit enhanced thermal conductivity.

In various approaches, refinement of grain size and/or changes in grain orientation may influence the material's mechanical properties, including its strength and ductility. In one approach, the zirconium-graphene covetic material may have enhanced mechanical strength relative to the mechanical strength of a zirconium material without graphene.

In some approaches, zirconium-graphene covetic materials may demonstrate changes to the material's structure and microstructure during exposure to intense radiation in a nuclear reactor environment. Graphene covetics in nuclear applications offer a remarkable capacity to withstand the harsh radiation environments in nuclear reactors. Given that material within nuclear reactors endure elevated radiation levels that can lead to degradation and reduced operational lifetimes, graphene covetics emerge as potential solutions with their exceptional mechanical strength and radiation-resistant attributes. In one approach, the zirconium-graphene covetic material may have enhanced resistance to radiation relative to the radiation resistance of a zirconium material without graphene.

In one approach, thermal changes in the zirconium-graphene covetic material may be important for designing fuel cladding materials capable of withstanding the extreme temperature fluctuations inherent in nuclear reactor environments. Effective thermal management is important in nuclear reactors to prevent overheating and ensure safe operation. In one approach, the zirconium-graphene covetic material may have enhanced thermal conductivity relative to the thermal conductivity of a zirconium material without graphene. By incorporating graphene into zirconium matrices, zirconium-graphene material can augment the heat dissipation capabilities of materials, potentially leading to more efficient cooling systems and enhanced reactor safety. In other approaches, graphene covetics may serve as coatings or additives in nuclear fuel pellets to enhance thermal conductivity and mechanical strength. This may improve fuel performance, increase fuel cycle efficiency, and extend the operational lifetimes of nuclear reactors.

In one approach, the zirconium-graphene covetic material may have enhancing corrosion resistance that is critical for preserving the longevity and effectiveness of fuel cladding materials throughout their operational lifespan. In one approach, the zirconium-graphene covetic material may have enhanced resistance to corrosion relative to the corrosion of a zirconium material without graphene. Graphene covetics exhibit promise the area of mitigating corrosion due to their protective graphene layers. Graphene covetics can resist chemical attacks and maintain their structural integrity over extended periods, potentially reducing the need for frequent maintenance and component replacement in nuclear facilities.

According to one aspect, plasma production tools currently exhibit the capability to generate graphene at rates by orders of magnitude that far surpass capabilities of any competing methods. Consequently, this remarkable efficiency may result in a cost-to-benefit ratio that makes large-scale manufacturing possible and economically advantageous.

Nuclear fuel cell cladding material

In one aspect, a nuclear fuel cell cladding material comprising zirconium-carbon covetic material includes a protective coating above a surface of the cladding material. The surface of the cladding is an exterior surface. In some approaches, the protective coating is applied to the exterior surface of the zirconium-carbon covetic material. Preferably, the protective coating is directly on the exterior surface of the zirconium-carbon covetic material that functions as a nuclear fuel cladding material. In one approach, the protective coating is melded onto the zirconium-carbon covetic material.

In various approaches, the protective coating includes silicon, carbide, alumina, zirconia, etc. In some approaches, the protective coating includes alloys comprised of a combination of two or more of the following: silicon, carbide, alumina, zirconia, etc. In some approaches, the protective coating includes metal oxides, nitrides, etc. The presence of metal oxides, nitrides, etc. in the protective coating may enhance resistance to nuclear radiation bombardment onto the cladding material.

In one aspect, the nuclear fuel cell cladding may be configured for use in a light water reactor. In other aspects, the nuclear fuel cell cladding may be configured for use in a light water reactor, in a pressurized water reactor, in a boiling water reactor, a heavy water reactor, etc. In yet other aspects, the nuclear fuel cell cladding may be configured to be used in a high-temperature gas-cooled reactor, a fast neuron reactor, a molten salt reactor, etc.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as important to the practice of the invention as claimed.

The aspects described herein included the one or more modes known to the inventor for carrying out the claimed subject matter. Of course, variations of those aspects will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A nuclear fuel cell cladding, comprising:
a zirconium-carbon covetic material comprising zirconium particles having a carbon component associated with a surface of the zirconium particles,
wherein an amount of the carbon component present in the zirconium-carbon covetic material is in a range of greater than 0.1 weight % to about 25weight % of the zirconium-carbon covetic material.

2. The nuclear fuel cell cladding of claim 1, wherein the carbon component is coupled to the surface of the zirconium particles.

3. The nuclear fuel cell cladding of claim 1, wherein the carbon component is covalently bound to the surface of the zirconium particles.

4. The nuclear fuel cell cladding of claim 1, wherein the carbon component is uniformly integrated within the zirconium-carbon covetic material.

5. The nuclear fuel cell cladding of claim 4, wherein the integrated carbon component in the zirconium-carbon covetic material has a physical characteristic of being integrated using a process of plasma-enhanced chemical vapor deposition.

6. The nuclear fuel cell cladding of claim 1, wherein the carbon component comprises at least one chosen from carbon nanotubes, carbon nanoplatelets, carbon nanomaterials, and graphene.

7. The nuclear fuel cell cladding of claim 1, wherein the zirconium particles includes a zirconium alloy.

8. The nuclear fuel cell cladding of claim 7, wherein the zirconium alloy comprises zirconium and at least one additional metal chosen from tin, iron, chromium, beryllium, magnesium, silicon, aluminum, molybdenum, niobium, vanadium, and nickel.

9. The nuclear fuel cell cladding of claim 1, further comprising, a protective coating above a surface of the cladding, wherein the surface of the cladding is an exterior surface.

10. The nuclear fuel cell cladding of claim 9, wherein the protective coating is directly on the exterior surface of the cladding.

11. The nuclear fuel cell cladding of claim 9, wherein the protective coating comprises a material chosen from silicon carbide, alumina, zirconia, and an alloy comprised of at least two of the materials thereof.

12. The nuclear fuel cell cladding of claim 9, wherein the protective coating comprises a material chosen from: metal oxides and nitrides.

13. The nuclear fuel cell cladding of claim 1, wherein the cladding is configured for use in a light water reactor.

14. The nuclear fuel cell cladding of claim 1, wherein the cladding is configured for use in a pressurized water reactor.

15. The nuclear fuel cell cladding of claim 1, wherein the cladding is configured for use in a boiling water reactor.

16. The nuclear fuel cell cladding of claim 1, wherein the cladding is configured for use in a high-temperature gas-cooled reactor.

17. The nuclear fuel cell cladding of claim 1, wherein the cladding is configured for use in a fast neutron reactor.

18. The nuclear fuel cell cladding of claim 1, wherein the cladding is configured for use in a molten salt reactor.

19. The nuclear fuel cell cladding of claim 1, wherein the cladding is configured for use in a heavy water reactor.
